(19) United States
(12) Patent Application Publication
(10) Pub. No.: US 2015/0042263 A1
(43) Pub. Date: Feb. 12, 2015

(54) Method for Balancing the Charge States of Battery Cells in a Battery and Battery for Implementation of the Method

(71) Applicants: Ralph Schmidt, Weinstadt (DE); Stefan Butzmann, Beilstein (DE); Holger Fink, Stuttgart (DE)

(72) Inventors: Ralph Schmidt, Weinstadt (DE); Stefan Butzmann, Beilstein (DE); Holger Fink, Stuttgart (DE)

(73) Assignees: Robert Bosch GmbH, Stuttgart (DE); Samsung SDI Co., Ltd., Yongin-si, Gyeonggi-do (KR)

(21) Appl. No.: 14/345,499

(22) PCT Filed: Aug. 28, 2012
(86) PCT No.: PCT/EP2012/066659

§ 371 Date: Oct. 29, 2014

(30) Foreign Application Priority Data
Sep. 19, 2011 (DE) 10 2011 082 973.

(51) Int. Cl. B60L 11/18; H02J 7/00

(52) U.S. Cl. CPC B60L 11/1866; H02J 7/0054; B60L 11/1809
USPC 320/104

(57) ABSTRACT

A method is described for the control of a battery comprising at least one battery module string with a number of battery modules connected in a series. Each battery module comprises at least one battery cell, at least one coupling unit, a first connection and a second connection and is designed for accommodating one of at least two switching states depending on an actuation of the coupling unit. Different switching states correspond to different voltage values between the first connection and the second connection of the battery module. A first and second output voltage of the battery module string are provided and applied to an inductivity during a first and second time interval. In the process, the second output voltage has the opposite polarity of the first output voltage.

The present invention relates to a method for balancing the states of charge of battery cells of a battery having at least one battery module string, in which a battery module in the battery module string comprises a coupling unit, and to a battery, in which the method according to the invention is implementable.

### PRIOR ART

It is apparent that, in future, battery systems will increasingly be used both in stationary applications and in vehicles such as hybrid and electric vehicles. In order to be able to meet the demands which are made for a respective application in terms of voltage and power that can be made available, a large number of battery cells are connected in series. Since the current provided by such a battery must flow through all the battery cells, and a battery cell can conduct only a limited current, battery cells are often additionally connected in parallel in order to increase the maximum current. This can be done either by providing a plurality of cell coils within a battery cell housing or by externally interconnecting battery cells. However, one problem in this case is that compensation currents between the battery cells which are connected in parallel may occur on account of cell capacitances and voltages which are not exactly identical.

FIG. 1 illustrates the basic circuit diagram of a conventional electric drive unit as is used, for example, in electric and hybrid vehicles or else in stationary applications such as for rotor blade adjustment in wind turbines. A battery 10 is connected to a DC voltage intermediate circuit which is buffered by an intermediate circuit capacitor 11. A pulse-controlled inverter 12 is connected to the DC voltage intermediate circuit and provides sinusoidal voltages, which are out of phase with respect to one another, at three taps 14-1, 14-2, 14-3 via in each case two switchable semiconductor valves and two diodes for the operation of an electric drive motor 13. The capacitance of the intermediate-circuit capacitor 11 must be high enough to stabilize the voltage in the DC voltage intermediate circuit for a period of time in which one of the switchable semiconductor valves is turned on. In a practical application, such as an electric vehicle, a high capacitance in the mF range is obtained.

The arrangement illustrated in FIG. 1 has the disadvantage that the weakest battery cell in the battery 10 determines the range and that a defect in a single battery cell already leads to failure of the entire vehicle. In addition, modulation of the high voltages in the pulse-controlled inverter 12 leads to high switching losses and—since insulated-gate bipolar transistor (IGBT) switches typically have to be used owing to the high voltages—likewise to high on-state losses.

A further disadvantage is that the same current flows through battery cells or modules contained in the system and therefore said battery cells or modules cannot be actuated individually. Therefore, there is no way to influence different states of individual battery cells.

In addition, the prior art has disclosed methods for balancing different states of charge (SOC) between individual battery cells or modules comprising same. The methods often require that an exchange of energy occurs between the battery cells and a connected load. When the electric vehicle is at a standstill, that is to say when no energy is being supplied to the load or taken therefrom, it is not possible to balance the different states of charge using said methods.

### DISCLOSURE OF THE INVENTION

According to the invention, a method for balancing the states of charge of battery cells of a battery is therefore provided. The battery comprises at least one battery module string having a plurality of series-connected battery modules. Each of the series-connected battery modules comprises at least one battery cell, at least one coupling unit, a first connection and a second connection and is designed to assume one of at least two switching states on the basis of actuation of the coupling unit. In this case, different switching states correspond to different voltage values between the first connection and the second connection of the battery module. Thus, in each of the switching states a different voltage value can be tapped off between the first connection and the second connection of the battery module.

The method according to the invention comprises the following steps: in a first method step, a first (not necessarily constant) output voltage of the battery module string is provided by suitable actuation of the battery modules in the battery module string and applied to an inductance during a first time interval, such that a current which flows through the inductance is increased. As a result of this, magnetic energy is stored in the inductance according to W=0.5L*I², wherein L is the self-inductance of the inductance and I is the current which flows through the inductance at the end of the first time interval.

In a second method step, a second (again, not necessarily constant) output voltage of the battery module string is provided by suitable actuation of the battery modules in the battery module string and applied to the inductance during a second time interval. In this case, the second output voltage has opposite polarity with respect to the first output voltage. The battery modules involved in providing the second output voltage are not exclusively the same battery modules as those involved in providing the first output voltage.

During the second method step, the magnetic energy stored in the inductance during the first method step is used to separate charges in the battery modules involved in providing the second output voltage, with the result that, after the second time interval has elapsed, said battery modules have a higher charge state than before.

Since, preferably, battery modules which have a higher charge state than those battery modules involved in providing the second output voltage are involved in providing the first output voltage, energy is shifted from the battery modules with a higher charge state into the battery modules with a lower charge state.

Typically, the second time interval directly follows the first time interval, and the method is periodically repeated.

At least one battery module can be designed either to connect the first connection and the second connection of the battery module or to connect the at least one battery cell between the first connection and the second connection, on the basis of actuation of the coupling unit. Two different switching states are defined hereby. In addition, at least one battery module can be designed to connect the at least one battery cell between the first connection and the second connection, wherein a polarity of the voltage present between the first connection and the second connection is selectable on the basis of actuation of the coupling unit. As a result of this, likewise two switching states emerge, or else three switching states, if the two configurations mentioned are combined with one another.

In a preferred embodiment of the invention, at least one battery module has the last-mentioned three switching states, wherein, in a first switching state, the first connection and the second connection of the battery module are connected, in a second switching state, the at least one battery cell is connected between the first connection and the second connection with a certain polarity (in one example, positive) and, in a third switching state, the at least one battery cell is connected between the first connection and the second connection with the opposite polarity (in the same example, negative).

It is also preferable that the battery module string comprises at least one first and one second battery module having the described three switching states, wherein the first battery module has a higher charge state than the second battery module. The method according to the invention is then implemented hereby such that, during the first time interval, the first battery module is in the second switching state and the second battery module is in the first switching state, while, during the second time interval, the first battery module is in the first switching state and the second battery module is in the third switching state.

In another preferred embodiment of the invention, at least one inductance of an electric motor connected to the battery is used as inductance. As a result of this, either a movement of the electric motor during the implementation of the method can be blocked or else, during a movement of the electric motor, the first and/or the second time interval can be selected such that the current which flows through the inductance of the electric motor in the first and/or second time interval does not contribute to a torque in the electric motor, as a result of which the magnetic energy stored in the inductance is not converted into kinetic energy, rather used only for charge separation. The invention thus provides a method which can be implemented both during operation of the motor and while a system driven by the motor is in the idle state (that is to say without a flow of energy).

A further aspect of the invention relates to a battery which comprises at least one battery module string having the properties described above. The battery is connectable to an inductance and is designed to implement the method according to the invention. In addition, it can be connectable to an inductance of an electric motor. The control device which is additionally required for full implementation of the method can be part of the battery, although this is not essential. The battery is preferably a lithium-ion battery.

Furthermore, a motor vehicle having an electric drive motor for driving the motor vehicle and a battery according to the invention connected to the electric drive motor is specified.

### DRAWINGS

Exemplary embodiments of the invention are explained in more detail with reference to the drawings and the following description, wherein identical reference signs indicate identical or functionally identical components. In the drawings:

FIG. 1 shows an electric drive unit according to the prior art,

FIG. 2 shows a coupling unit which is usable in the method according to the invention,

FIG. 3 shows a first embodiment of the coupling unit,

FIG. 4 shows a second embodiment of the coupling unit,

FIG. 5 shows the second embodiment of the coupling unit in a simple semiconductor circuit,

FIGS. 6 and 7 show two arrangements of the coupling unit in a battery module,

FIG. 8 shows the coupling unit illustrated in FIG. 5 in the arrangement illustrated in FIG. 6,

FIG. 9 shows an electric drive unit having three battery module strings,

FIG. 10 shows actuation of the electric drive unit shown in FIG. 9 by means of a control device,

FIG. 11 shows an embodiment of the coupling unit which makes it possible for a voltage with selectable polarity to be present between the connections of a battery module,

FIG. 12 shows an embodiment of the battery module having the coupling unit illustrated in FIG. 11,

FIGS. 13 and 14 schematically show the method according to the invention during a first time interval Δt₁ and a second time interval Δt₂,

FIG. 15 shows a time profile of a voltage present across the inductance L illustrated in FIGS. 13 and 14, and

FIG. 16 shows the corresponding profile of a current which flows through the inductance L.

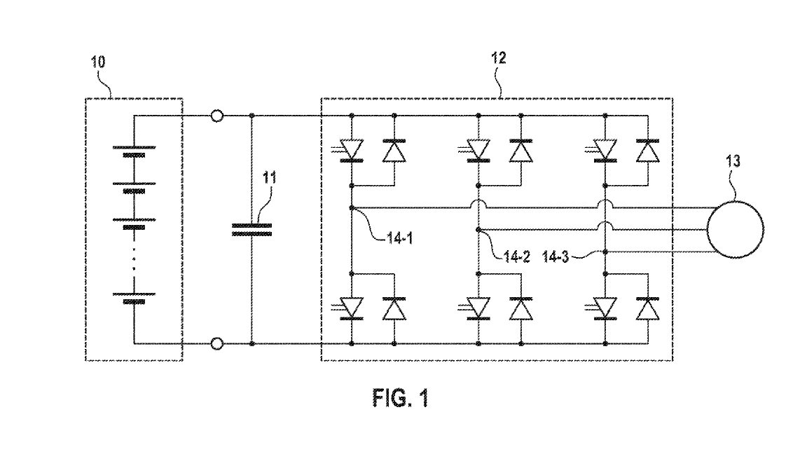

### EMBODIMENTS OF THE INVENTION

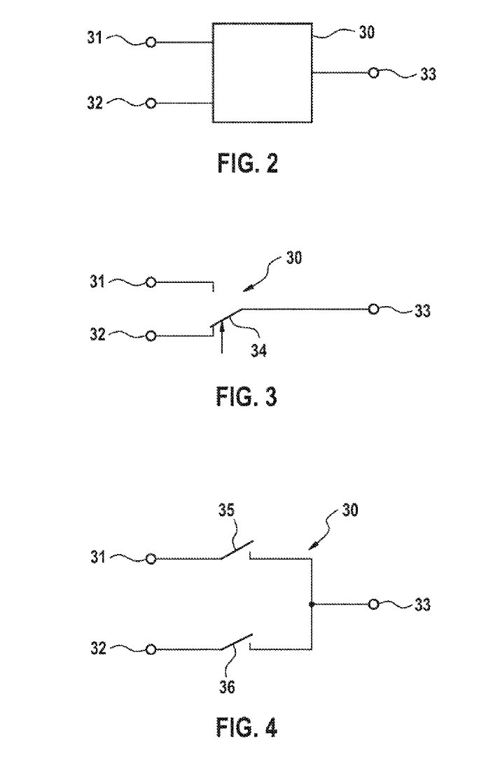

FIG. 2 shows a coupling unit 30 which is usable in the method according to the invention. The coupling unit 30 has two inputs 31 and 32 and an output 33 and is designed to connect one of the inputs 31 or 32 to the output 33 and to decouple the other. In certain embodiments of the coupling unit, the latter can additionally be designed to disconnect both inputs 31 and 32 from the output 33. However, provision is not made to connect both input 31 and input 32 to the output 33.

FIG. 3 shows a first embodiment of the coupling unit 30 which has a changeover switch 34 which, in principle, can connect only one of the two inputs 31, 32 to the output 33, while the respective other input 31, 32 is decoupled from the output 33. The changeover switch 34 can be realized in a particularly simple manner as an electromechanical switch.

FIG. 4 shows a second embodiment of the coupling unit 30, in which a first and a second switch 35 and 36, respectively, are provided. Each of the switches is connected between one of the inputs 31 and 32, respectively, and the output 33. In contrast to the embodiment in FIG. 3, this embodiment offers the advantage that both inputs 31, 32 can also be decoupled from the output 33, with the result that the output 33 becomes highly resistive. Moreover, the switches 35, 36 can be realized in a simple manner as semiconductor switches, such as metal-oxide semiconductor field-effect transistor (MOSFET) switches or insulated-gate bipolar transistor (IGBT) switches. Semiconductor switches afford the advantage of being inexpensive and having a high switching speed, with the result that the coupling unit 30 can react within a short time to a control signal or to a change in the control signal and high switchover rates are achievable.

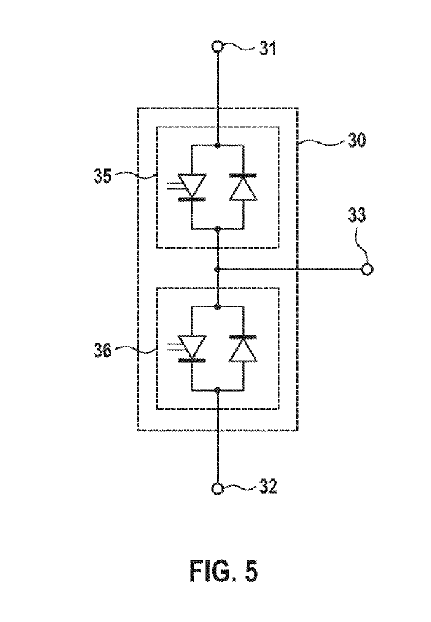

FIG. 5 shows the second embodiment of the coupling unit in a simple semiconductor circuit, in which each of the switches 35, 36 comprises in each case a semiconductor valve which can be switched on and off and a diode connected back-to-back in parallel therewith.

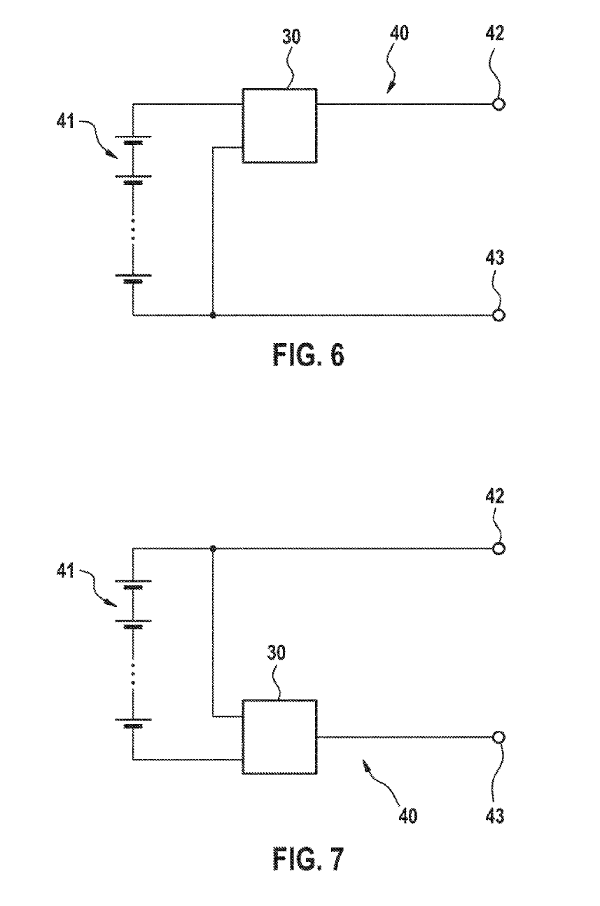

FIGS. 6 and 7 show two arrangements of the coupling unit 30 in a battery module 40. A plurality of battery cells 41 is connected in series between the inputs of a coupling unit 30. However, the invention is not restricted to a series connection of battery cells such as this; it is also possible for only a single battery cell to be provided or else a parallel connection or mixed series-parallel connection of battery cells. In the example in FIG. 6, the output of the coupling unit 30 is connected to a first connection 42 and the negative pole of the battery cells 41 is connected to a second connection 43. However, a mirror-image arrangement, as in FIG. 7, in which the positive pole of the battery cells 41 is connected to the first connection 42 and the output of the coupling unit 30 is connected to the second connection 43, is possible.

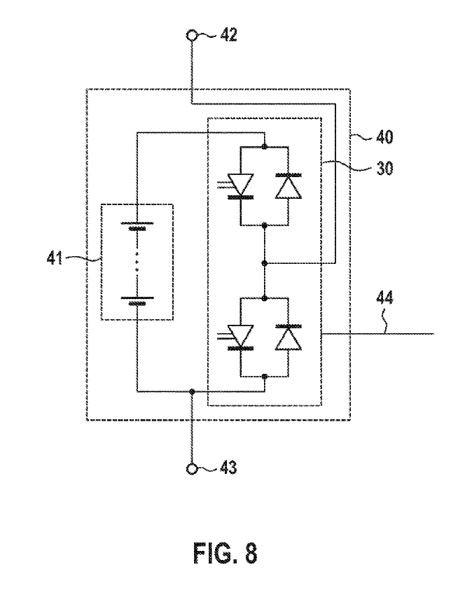

FIG. 8 shows the coupling unit 30 illustrated in FIG. 5 in the arrangement illustrated in FIG. 6. Actuation and diagnosis of the coupling units 30 take place via a signal line 44 which is connected to a control device (not illustrated). Overall, it is possible to set either 0 volt or a voltage U_{mod} between the connections 42 and 43 of the battery module 40.

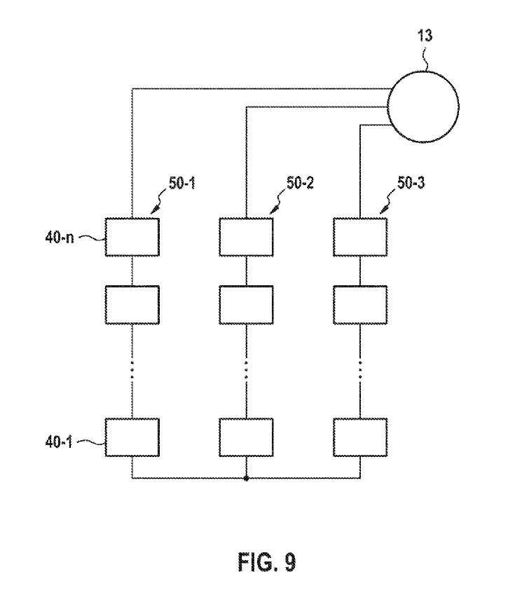

FIG. 9 shows an electric drive unit having an electric motor 13, the three phases of which are connected to three battery module strings 50-1, 50-2, 50-3. Each of the three battery module strings 50-1, 50-2, 50-3 consists of a plurality of series-connected battery modules 40-1, . . . , 40-n, which in each case comprise a coupling unit 30 and are constructed as illustrated in FIG. 6 or 7. In the case of the assembly of battery modules 40-1, . . . , 40-n to form one of the battery module strings 50-1, 50-2, 50-3, in each case the first connection 42 of a battery module 40-1, . . . , 40-n is connected to the second connection 43 of an adjacent battery module 40-1, . . . , 40-n. In this way, a stepped output voltage can be produced in each of the three battery module strings 50-1, 50-2, 50-3.

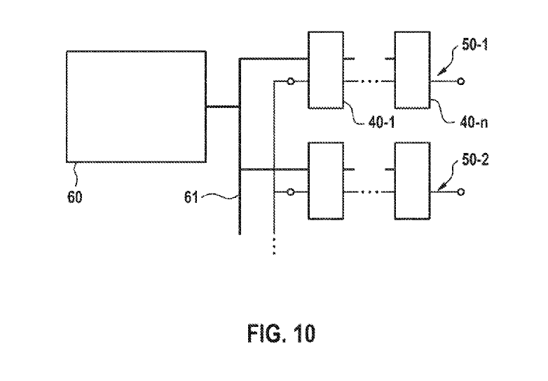

A control device 60 shown in FIG. 10 is designed to output a first control signal to a variable number of battery modules 40-1, . . . , 40-n in m battery module strings 50-1, 50-2, . . . , 50-m via a data bus 61, by means of which control signal the coupling units 30 of the battery modules 40-1, . . . , 40-n controlled in this way connect the battery cell (or the battery cells) 41 between the first connection 42 and the second connection 43 of the respective battery module 40-1, . . . , 40-n. At the same time, the control device 60 outputs a second control signal to the remaining battery modules 40-1, . . . , 40-n, by means of which control signal the coupling units 30 of said remaining battery modules 40-1, . . . , 40-n connect the first connection 42 and the second connection 43 of the respective battery module 40-1, . . . , 40-n, as a result of which the battery cells 41 thereof are bridged.

By suitable actuation of the plurality of battery modules 40-1, . . . , 40-n in m battery module strings 50-1, 50-2, . . . , 50-m, m sinusoidal output voltages can thus be produced which actuate the electric motor 13 in the desired form without the use of an additional pulse-controlled inverter.

In another embodiment, it is provided that the battery modules 40-1, . . . , 40-n used in one of the m battery module strings 50-1, 50-2, . . . , 50-m are designed to connect their battery cells 41 between the first connection 42 and the second connection 43 such that a polarity of the voltage present between the first connection 42 and the second connection 43 is selectable on the basis of actuation of the coupling unit.

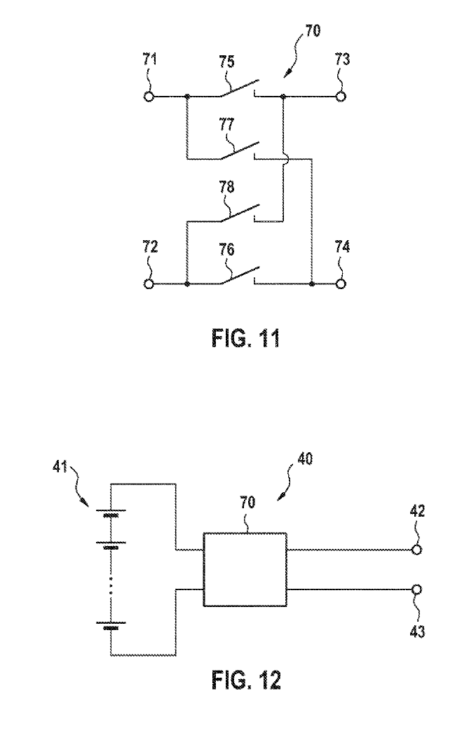

FIG. 11 shows an embodiment of the coupling unit 70 which makes this possible and in which a first, a second, a third and a fourth switch 75, 76, 77 and 78 are provided. The first switch 75 is connected between a first input 71 and a first output 73, the second switch 76 is connected between a second input 72 and a second output 74, the third switch 77 is connected between the first input 71 and the second output 74 and the fourth switch 78 is connected between the second input 72 and the first output 73.

FIG. 12 shows an embodiment of the battery module 40 with the coupling unit illustrated in FIG. 11. The first output of the coupling unit 70 is connected to the first connection 42 and the second output of the coupling unit 70 is connected to the second connection 43 of the battery module 40. The battery module 40 constructed in this way affords the advantage that the battery cells 41 can be connected by the coupling unit 70 to the connections 42, 43 with a selectable polarity, with the result that an output voltage with different mathematical signs can be produced. It can also be possible, for example by closing the switches 76 and 78 and simultaneously opening the switches 75 and 77 (or else by opening the switches 76 and 78 and closing the switches 75 and 77), to connect the connections 42 and 43 conductively to one another and to generate an output voltage of 0 V. Overall, it is thus possible to set either 0 volt, the voltage U_{mod} or the voltage −U_{mod} between the connections 42 and 43 of the battery module 40.

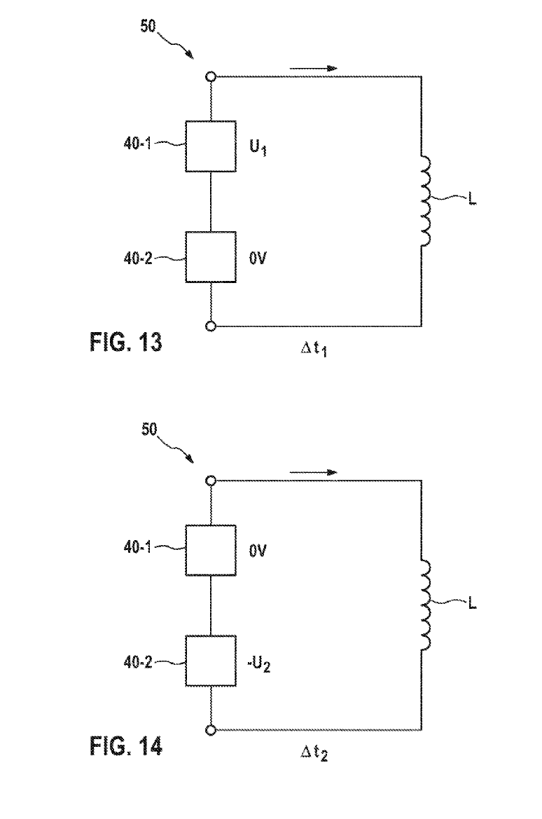

The method according to the invention for balancing the states of charge of battery cells of a battery will be described in the following text with reference to FIGS. 13 to 16. The method is implemented using a battery module string 50 which comprises battery modules 40 having the properties described above. In particular, the battery modules 40 illustrated in FIGS. 6 to 8 can be used for this purpose. Preferably, however, the method according to the invention is implemented using a battery module string 50 which comprises a plurality of series-connected battery modules 40, which are implemented as illustrated in FIG. 12 and comprise in each case the coupling element 70 illustrated in FIG. 11.

Said embodiment of the battery module 40 is, as explained above, designed to take selectively one of at least three switching states on the basis of actuation of the coupling unit. In a first switching state, the first connection 42 and the second connection 43 of the battery module 40 are connected. In a second switching state, the plurality of battery cells 41 is connected between the first connection 42 and the second connection 43 with a positive polarity. Finally, in a third switching state, the plurality of battery cells 41 is connected between the first connection 42 and the second connection 43 with a negative polarity.

FIGS. 13 and 14 schematically show the method according to the invention during a first time interval Δt₁ and a second time interval Δt₂.

The battery module string 50 illustrated in FIG. 13 and FIG. 14 comprises two battery modules 40-1, 40-2, wherein both battery modules 40-1, 40-2 have the preferred three switching states described above. The battery module string 50 is connected by means of the two connections thereof to an inductance L, wherein the output voltage, which is produced by the battery module string 50, is present across the inductance L.

Before the start of the method according to the invention, there is no current flowing through the inductance L. The first battery module 40-1 has a higher charge state than the second battery module 40-2.

Now, as illustrated in FIG. 13, a first output voltage +U₁ is produced during a first time interval Δt₁. The first output voltage +U₁ is provided by virtue of the fact that the first battery module 40-1 is in the second switching state, as a result of which a voltage U₁ is produced, and the fact that the second battery module 40-2 is in the first switching state, as a result of which said second battery module does not contribute to the first output voltage. As a result of this, a current begins to flow through the inductance L, which current increases linearly and leads to the inductance L storing magnetic energy.

During the second time interval Δt₂, as illustrated in FIG. 14, the first battery module 40-1 is in the first switching state and the second battery module 40-2 is in the third switching state. Thus, the first battery module 40-1 does not make any contribution and the second battery module 40-2 makes the contribution −U₂ to the second output voltage. Although a voltage with an opposite polarity is now present across the inductance L, the current still flows—as indicated by arrows in FIGS. 13 and 14—in the same direction during the second time interval Δt₂ as during the first time interval Δt₁, but decreases linearly. As a result of this, there is a decrease in the magnetic energy stored in the inductance L, which magnetic energy leads to separation of charges in the second battery module 40-2.

At the end of the second time interval Δt₂, the first battery module 40-1 thus has a lower charge state than at the start of the method, and the second battery module 40-2 has a higher one.

The method according to the invention can be applied without problems to the case in which the battery module string 50 comprises a greater number of battery modules 40. In this case, preferably, those battery modules which have a higher charge state than the battery modules involved in providing the second output voltage are involved in providing the first output voltage during the first time interval Δt₁. As a result of this, there is an overall exchange of charge between the battery cells of the different battery modules, and the different states of charge of the battery modules are balanced.

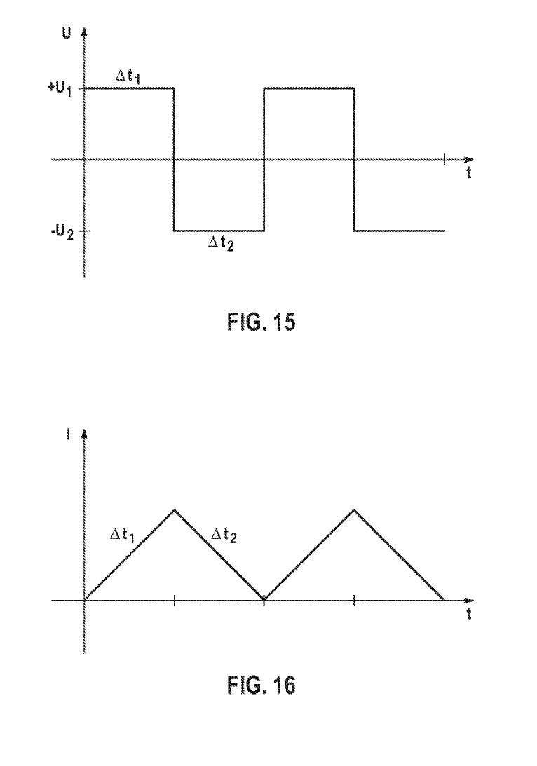

FIG. 15 shows a profile of a voltage present across the inductance L during the first time interval Δt₁ and the second time interval Δt₂. As illustrated in FIG. 15, the method according to the invention can be periodically repeated, as a result of which a gradual and continual shift of charge between the different modules is possible.

FIG. 16 shows the corresponding profile of a current which flows through the inductance L. An ideal inductance L has a linear current profile which, with suitable selection of the time intervals Δt₁ and Δt₂, does not ever change its mathematical sign. In an exemplary embodiment which is not shown, an average current is set and has an AC component superimposed thereon.

Under idealized preconditions, the process illustrated in FIGS. 15 and 16 proceeds without losses. Of course, in reality, both the semiconductor components which are used as switches in the battery modules 40 and the inductance L are lossy. Thus, not all of the energy drawn from the battery module 40-1 is stored in the battery module 40-2.

In an exemplary embodiment of the invention which is not shown in more detail, an inductance of the electric motor 13, which is connected to the battery 10, for example a permanent magnet synchronous motor, is used as inductance L. Since in practice most of all the motors used are three-phase motors, in this case the arrangement can be as illustrated in FIG. 9. However, the method according to the invention is also applicable to n-phase systems. It is advantageous, in the case of use of the inductance of the electric motor 13 connected to the battery 10, for all components necessary for implementing the method according to the invention already to be present in the overall system.

In order to ensure that the magnetic energy stored in the inductance L is not converted into kinetic energy but rather used only for charge separation, the drive system should be in the idle state. More precisely, the drive system must be firmly braked, that is to say the torque arising during the implementation of the method according to the invention is not permitted to exceed the breakaway torque necessary for a movement of the motor. (In the case of an asynchronous machine, there is no danger of this as no torque occurs here).

Alternatively, the method according to the invention can also be implemented in the event of a movement of the drive system. When describing synchronous and asynchronous machines, it is common to use a rotating coordinate system. The axes of said coordinate system are designated d-q and rotate with the speed of the magnetic field, wherein the d axis is oriented, by definition, in the direction of the field. In the case of a symmetrical synchronous machine, the current running in the d direction does not contribute to torque generation. Thus, the method described above can be implemented by the build-up and decrease of a current in this direction. Only the rotation of the current space vector should be taken into account when selecting the battery module to be activated. Only a particular angle range in which the current can be built up is available for a given battery module. Likewise, only a particular angle range is available for a battery module by means of which the current is to be decreased again.

1. A method for balancing states of charge of battery cells of a battery comprising at least one battery module string having a plurality of series-connected battery modules, wherein each battery module comprises at least one battery cell, at least one coupling unit, a first connection and a second connection and is configured to take one of at least two switching states on the basis of actuation of the coupling unit, wherein different switching states correspond to different voltage values between the first connection and the second connection of the battery module, the method comprising:
actuating the battery modules in the battery module string to provide a first output voltage of the battery module string; and
applying the first output voltage to an inductance during a first time interval, such that a current which flows through the inductance is increased;
actuating the battery modules in the battery module string to provide a second output voltage of the battery module string; and
applying the second output voltage to an inductance during a second time interval,
wherein the second output voltage has opposite polarity with respect to the first output voltage, and
wherein the battery modules involved in providing the second output voltage are not exclusively the same battery modules as those involved in providing the first output voltage.

2. The method as claimed in claim 1, wherein, the battery modules involved in providing the first output voltage have a higher charge state than the battery modules involved in providing the second output voltage.

3. The method as claimed in claim 1, wherein the second time interval directly follows the first time interval.

4. The method as claimed in claim 1, wherein the method is periodically repeated.

5. The method as claimed in claim 1, wherein:
at least one battery module is configured to take selectively one of at least three switching states based on actuation of the coupling unit,
in a first switching state, the first connection and the second connection of the battery module are connected,
in a second switching state, the at least one battery cell is connected between the first connection and the second connection with a first polarity, and
in a third switching state, the at least one battery cell is connected between the first connection and the second connection with a polarity opposite to the first polarity.

6. The method as claimed in claim 5, wherein:
the at least one battery module configured to take selectively one of at least three switching states includes at least one first battery module and one second battery module,
the first battery module has a higher charge state than the second battery module,
during the first time interval, the first battery module is in the second switching state and the second battery module is in the first switching state, and
during the second time interval, the first battery module is in the first switching state and the second battery module is in the third switching state.

7. The method as claimed in claim 1, wherein at least one inductance of an electric motor connected to the battery is used as the inductance.

8. The method as claimed in claim 7, wherein a movement of the electric motor is blocked during performance of the method.

9. The method as claimed in claim 7, wherein, during a movement of the electric motor, the first time interval and/or the second time interval are selected such that the current which flows through the inductance of the electric motor in the first time interval and/or second time interval does not contribute to a torque in the electric motor.

10. A battery comprising:
at least one battery module string having a plurality of series-connected battery modules, each battery module including at least one battery cell, at least one coupling unit, a first connection and a second connection, and each battery module is configured to take one of at least two switching states based on actuation of the coupling unit,
wherein different switching states correspond to different voltage values between the first connection and the second connection of the battery module,
wherein the battery is connectable to an inductance and is configured to implement a method for balancing states of charge of the at least one battery cell,
wherein the method includes
actuating the battery modules in the battery module string to provide a first output voltage of the battery module string,
applying the first output voltage to an inductance during a first time interval, such that a current which flows through the inductance is increased,
actuating the battery modules in the battery module string to provide a second output voltage of the battery module string, and
applying the second output voltage to an inductance during a second time interval,
wherein the second output voltage has opposite polarity with respect to the first output voltage, and
wherein the battery modules involved in providing the second output voltage are not exclusively the same battery modules as those involved in providing the first output voltage.

11. The battery as claimed in claim 10, wherein the battery is connectable to an inductance of an electric drive motor.

12. A motor vehicle having comprising:
an electric drive motor for driving configured to drive the motor vehicle; and
a battery connected to an inductance of the electric drive motor, the battery including at least one battery module string having a plurality of series-connected battery modules, each battery module including at least one battery cell, at least one coupling unit, a first connection and a second connection, and each battery module is configured to take one of at least two switching states based on actuation of the coupling unit,
wherein different switching states correspond to different voltage values between the first connection and the second connection of the battery module,
wherein the battery is connectable to an inductance and is configured to implement a method for balancing states of charge of the at least one battery cell,
wherein the method includes
actuating the battery modules in the battery module string to provide a first output voltage of the battery module string,
applying the first output voltage to an inductance during a first time interval, such that a current which flows through the inductance is increased,
actuating the battery modules in the battery module string to provide a second output voltage of the battery module string, and
applying the second output voltage to an inductance during a second time interval,
wherein the second output voltage has opposite polarity with respect to the first output voltage, and
wherein the battery modules involved in providing the second output voltage are not exclusively the same battery modules as those involved in providing the first output voltage.
